(19) United States
(12) Patent Application Publication
(10) Pub. No.: US 2025/0018283 A1
(43) Pub. Date: Jan. 16, 2025

(54) REMOTE CONTROL OF A MOBILE DEVICE

(71) Applicant: Caavo Inc, Milpitas, CA (US)

(72) Inventors: Ashish AGGARWAL, Stevenson Ranch, CA (US); Jason Gary KRIKORIAN, Woodside, CA (US)

(73) Assignee: Caavo Inc, Milpitas, CA (US)

(21) Appl. No.: 18/768,793

(22) Filed: Jul. 10, 2024

Related U.S. Application Data
(60) Provisional application No. 63/513,455, filed on Jul. 13, 2023.

(51) Int. Cl. A63F 13/23; A63F 13/2145; G06F 3/0487

(52) U.S. Cl. CPC A63F 13/23; A63F 13/2145; G06F 3/0487; A63F 2300/204

(57) ABSTRACT

Embodiments described herein enable remote control of a mobile device. A representation of a screen displayed on a mobile device is obtained by an emulating device. The emulating device transmits the representation of the screen to a first computing device. The emulating device receives, from the first computing device, a control command comprising instructions to perform an action with respect to the mobile device. The emulating device converts the control command to an input command based on an input device emulated by the emulating device. The emulating device transmits the input command to the mobile device. In a further aspect, control of the mobile device by external devices is restricted to input devices capable of interfacing with an accessibility interface of the mobile device to provide input user interface commands. In this further aspect, the emulating device interfaced with the accessibility interface.

### CROSS-REFERENCE TO RELATED APPLICATIONS

This application claims the benefit of U.S. Provisional Patent Application No. 63/513,455, filed Jul. 13, 2023, the content of which is incorporated by reference herein in its entirety.

### BACKGROUND

Mobile devices may be configured to restrict input from external devices. However, there are some cases where a user of a mobile device desires allowing a user of an external device to externally control their device.

### BRIEF SUMMARY

Methods, systems, and apparatuses are described herein for enabling remote control of a mobile device, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system for remotely controlling a mobile device, according to an exemplary embodiment.

FIG. 2A is a flowchart of a process for enabling remote control of a mobile device, according to an exemplary embodiment.

FIG. 2B is an example block diagram of the emulating device of FIG. 1.

FIG. 3 is a block diagram of a system for receiving a representation of a screen from a mobile device via a local connection and remotely controlling the mobile device, according to an exemplary embodiment.

FIG. 4 is a flowchart of a process for receiving a representation of a screen from a mobile device via a local connection and remotely controlling the mobile device, according to an exemplary embodiment.

FIG. 5 is a block diagram of a system for receiving a representation of a screen from a mobile device via a screen capturing application and remotely controlling the mobile device, according to an exemplary embodiment.

FIG. 6 is a flowchart of a process for receiving a representation of a screen from a mobile device via a screen capturing application and remotely controlling the mobile device, according to an exemplary embodiment

FIG. 7 is a block diagram of a mobile device paired to an emulating device, according to an exemplary embodiment.

FIG. 8 is a block diagram of a system for remotely controlling a mobile device, according to an exemplary embodiment.

FIG. 9 is a block diagram of a media system configured to enable remote control of a mobile device, according to an exemplary embodiment.

FIG. 10 is a block diagram of a computer system, according to an exemplary embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous exemplary embodiments are described herein. Any section/subsection headings provided herein are not intended to be limiting. Embodiments are described throughout this document, and each embodiment may be eligible for inclusion within multiple different sections or subsections. Furthermore, it is contemplated that the disclosed embodiments may be combined with each other in any manner. That is, the embodiments described herein are not mutually exclusive of each other and may be practiced and/or implemented alone, or in any combination.

An emulating device is described herein. The emulating device comprising a processor circuit and a memory. The memory stores program code structured to cause the processor circuit to: obtain a representation of a screen displayed on a mobile device; transmit the representation of the screen to a first computing device; receive, from the first computing device, a control command comprising instructions to perform an action with respect to the mobile device; convert the control command to an input command based on an input device emulated by the emulating device; and transmit the input command to the mobile device.

In an implementation of the emulating device, the program code is further structured to cause the processor circuit to: establish a connection with the mobile device by emulating the input device; and transmit the input command via the established connection.

In an implementation of the emulating device, control of the mobile device by external devices is restricted to input devices capable of interfacing with an accessibility interface of the mobile device to provide input user interface commands. The emulating device interfaces with the accessibility interface.

In an implementation of the emulating device, the emulating device is configured to: emulate a microphone input device; emulate a universal switch input device; emulate a game controller input device; emulate a joystick input device; emulate a keyboard input device; or emulate a mouse input device.

In an implementation of the emulating device, the emulating device is coupled to the mobile device by a local connection, the local connection comprising: a wired connection; or a peer-to-peer network connection.

In an implementation of the emulating device, the emulating device is coupled to the first computing device by a wireless network.

In an implementation of the emulating device, to enable the processor circuit to obtain the representation of the screen, the emulating device is configured to receive a video signal from the mobile device via the local connection.

In an implementation of the emulating device, to enable the processor circuit to obtain the representation of the screen, the emulating device is configured to receive the representation of the screen from a screen capturing application executing on the mobile device.

In an implementation of the emulating device, the emulating device is: a switching device; a mobile device dock; or a second computing device.

A system comprising any of the foregoing implementations of the emulating device is described herein.

A method performed by an emulating device is described herein. The method comprising: obtaining a representation of a screen displayed on a mobile device; transmitting the representation of the screen to a first computing device; receiving, from the first computing device, a control command comprising instructions to perform an action with respect to the mobile device; converting the control command to an input command based on an input device emulated by the emulating device; and transmitting the input command to the mobile device.

In an implementation of the method, the method further comprises: establishing a connection with the mobile device by emulating the input device; and transmitting the input command via the established connection.

In an implementation of the method, control of the mobile device by external devices is restricted to input devices capable of interfacing with an accessibility interface of the mobile device to provide input user interface commands. The emulating device interfaced with the accessibility interface.

In an implementation of the method, the method further comprises at least one of: emulating a microphone input device; emulating a universal switch input device; emulating a game controller input device; emulating a joystick input device; emulating a keyboard input device; or emulating a mouse input device.

In an implementation of the method, said obtaining a representation of a screen comprises: receiving a video signal from the mobile device via a local connection between the mobile device and the emulating device; or receiving the representation of the screen from a screen capturing application executing on the mobile device.

A computer-readable storage medium is described herein. The computer-readable storage medium encoded with program instructions that, when executed by a processor circuit, performs any of the foregoing implementations of the method.

A switching device is described herein. The switching device comprises a plurality of ports, a screen obtainer, and a control emulator. The plurality of ports comprises a first port communicatively coupled to a mobile device. The screen obtainer is configured to: obtain a representation of a screen displayed on the mobile device and transmit the representation of the screen to a first computing device. The control emulator is configured to: receive, from the first computing device, a control command comprising instructions to perform an action with respect to the mobile device, convert the control command to an input command based on an input device emulated by the emulating device, and transmit the input command to the mobile device.

In an implementation of the switching device, control of the mobile device by external devices is restricted to input devices capable of interfacing with an accessibility interface of the mobile device to provide input user interface commands; and the control emulator interfaced with the accessibility interface.

In an implementation of the switching device, the switching device is configured to: receive, at the first port, a media content signal from the mobile device; to obtain a representation of a screen displayed on the mobile device, the switching device is further configured to: capture the representation of the screen from the media content signal.

In an implementation of the switching device, the control emulator is communicatively coupled to the mobile device by an established connection, the established connection comprising: a connection between a second port of the plurality of ports and the mobile device, or a connection between a network interface of the switching device and the mobile device; and to transmit the input command to the mobile device, the control emulator is configured to transmit the input command using the established connection.

In an implementation of the switching device, wherein to transmit the input command to the mobile device, the control emulator is configured to transmit the input command via the first port.

In an implementation of the switching device, wherein the control emulator is further configured to: emulate a microphone input device; emulate a universal switch input device; emulate a game controller input device; emulate a joystick input device; emulate a keyboard input device; or emulate a mouse input device.

A system comprising any of the foregoing implementations of the switching device is described herein.

### II. Example Embodiments

Mobile devices may be configured to restrict what type of external devices can provide input user interface commands to the mobile device. For instance, a mobile device may be configured to restrict such external devices to input devices capable of interfacing with an accessibility interface of the mobile device to provide input user interface commands. There are some scenarios where a user of a mobile device desires allowing a user of an external device to externally control their device. For example, a first user of a mobile device may be experiencing service issues with an application or the mobile device. In this example, the first user may desire enabling a second user (e.g., a user of another mobile device, a user known by the first user (e.g., a family member, a friend, etc.), a service team user (e.g., a developer or service team user of the application, a service team user of the mobile device, a third party repair service user, etc.), etc.) to view and control the mobile device using an external device. In some situations, the second user is located remotely from the first user (e.g., located in a different building than the first user, a different geographic location (e.g., another city, state, region, country, etc.), or otherwise located in a different area than the first user).

Embodiments are provided for enabling remote control of a mobile device. In embodiments, an emulating device located near the mobile device enables the remote device to control the mobile device. In one aspect, the emulating device is configured to obtain a representation of a screen displayed on the mobile device (e.g., as a video signal or image signal over a connection (e.g., a wireless connection (e.g., a near field communication (NFC) connection, a wireless local area network (LAN) connection, a wireless personal area network (PAN) (e.g., using technologies such as ZigBee® that are based on the IEEE 802.15.4 standard for wireless personal area networks), a Bluetooth® network, as described in the various standards developed and licensed by Bluetooth™ Special Interest Group, other RF-based or IP-based communication technologies (e.g., IEEE 802.11 protocols), etc.), a wired connection (e.g., an ethernet connection, a universal serial bus (USB) connection, a high-definition multimedia interface (HDMI) connection, a Lightning® connection, etc.), or a combination of wireless and wired connections) to the mobile device or as a video or image stream or file from an application executing on the mobile device). The emulating device transmits the representation of the screen to the remote device (e.g., over a network (e.g., a wide area network (WAN), the Internet, a cellular network, a mobile network, or other long distance network)). The emulating device receives a control command from the remote device. The control command comprises instructions to perform an action with respect to the mobile device. The emulating device converts the control command to an input command based on an input device (e.g., a keyboard, a mouse, a universal button, a joystick, etc.) emulated by the emulating device and transmits the input command to the mobile device.

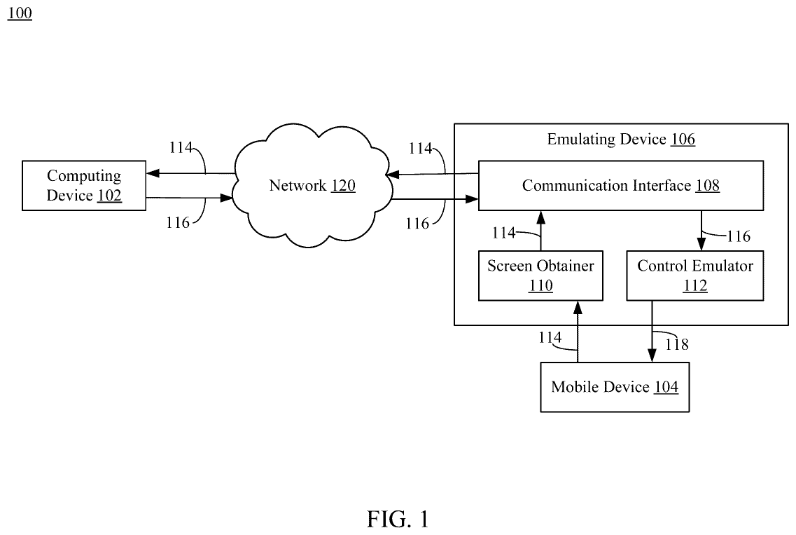

Embodiments may be configured in various ways in various embodiments. For example, FIG. 1 is a block diagram of a system 100 for remotely controlling a mobile device, according to an exemplary embodiment. As shown in FIG. 1, system 100 includes a computing device 102, a mobile device 104, and an emulating device 106. Computing device 102 and emulating device 106 are communicatively coupled over a network 120.

Computing device 102 may be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 102 is associated with a user (e.g., an individual user, a group of users, an organization, a family user, a customer user, an employee user, an admin user (e.g., a service team user, a developer user, a management user, etc.), etc.). In embodiments, computing device 102 is remotely located from mobile device 104.

Mobile device 104 may be any type of mobile processing device, including, but not limited to, a tablet, a personal data assistant (PDA), a smart phone, a laptop, etc. In accordance with an embodiment, mobile device 104 is associated with a user (e.g., an individual user, a group of users, an organization, a family user, a customer user, an employee user, an admin user (e.g., a service team user, a developer user, a management user, etc.), etc.). In embodiments, mobile device 104 is located local to emulating device 106 (e.g., in the same room, in the same building, via the same LAN, within a predetermined distance (e.g., a number of inches, a number of feet, a number of yards, a number of meters, and/or the like), or otherwise geographically proximate to emulating device 106).

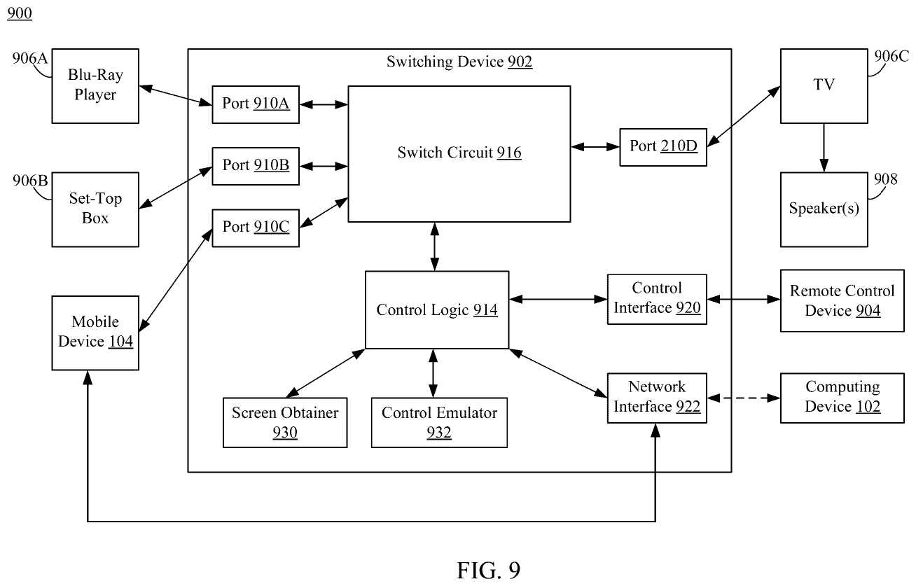

Emulating device 106 is configured to enable remote control of mobile device 104 by computing device 102. Examples of emulating device 106 include, but are not limited to, a mobile device docking station, a switching device (e.g., as discussed further with respect to FIG. 9), a computing device, a special purpose capturing and emulating device, or another device configured to obtain representations of screens displayed by a mobile device and enable remote control of the mobile device, as described elsewhere herein. As shown in FIG. 1, emulating device 106 comprises a communication interface 108, a screen obtainer 110, and a control emulator 112. Communication interface 108 may include any type or number of wired and/or wireless communication or network adapters, modems, etc., configured to enable emulating device 106 to communicate intra-system with components thereof, as well as to communicate with other devices and/or systems over a network, such as communications between emulating device 106 and computing device 102 over network 120 or communications between emulating device 106 and mobile device 104 (e.g., over established connections between emulating device 106 and mobile device 104). In accordance with an embodiment, screen obtainer and/or control emulator are services executing on emulating device 106.

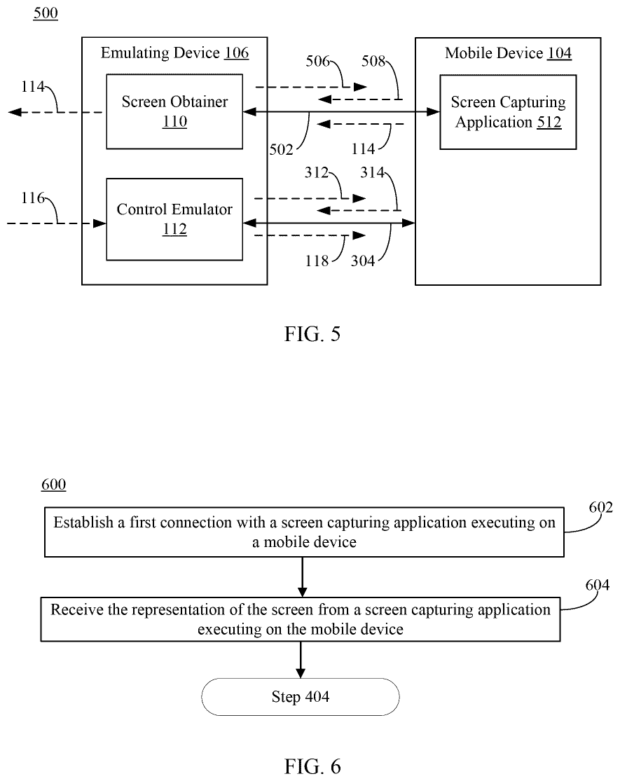

Screen obtainer 110 is configured to obtain representations of screens displayed on mobile devices and transmit the obtained representations to (e.g., remotely located) computing devices (e.g., using communication interface 108). For instance, as shown in FIG. 1, screen obtainer 110 obtains a representation 114 from mobile device 104 and transmits representation 114 to computing device 102 over network 120 via communication interface 108. In accordance with an embodiment, and as further discussed with respect to FIGS. 5 and 6, screen obtainer 110 communicates with a screen capturing application executing on mobile device 104 to obtain representation 114. In accordance with another embodiment, screen obtainer 110 (or another component of emulating device 106) receives video or image signals from mobile device 104 and obtains representation 114 from the video or image signals (e.g., by analyzing the video or image signals).

Control emulator 112 is configured to emulate an input device and convert command signals received from remotely located computing devices to input commands to be transmitted to mobile devices. Control emulator 112 may be configured to emulate any number of input devices or any type of input devices. Examples of emulated input devices include, but are not limited to, universal switches, game controllers, joysticks, keyboards, mouses, styluses, microphones, and/or the like. Control emulator 112 may generate or use an artificial identifier as an identifier of the emulated input device (e.g., an artificial media access control (MAC) address, an artificial internet protocol (IP) address, a type of the emulated input device, an artificial model number of the emulated device, other (e.g., artificial) information associated with the emulated input device, etc.). In accordance with an embodiment, control emulator 112 determines an input device type to emulate based on a selection made in a user interface of mobile device 104. In this context, mobile device 104 may transmit an indication of the selection (not shown in FIG. 1 for brevity) to emulating device 106. Alternatively, emulating device 106 determines the selection from representation 114. In another alternative embodiment, control emulator 112 determines the input device type to emulate based on a selection made in a user interface of computing device 102. In another alternative embodiment, control emulator 112 determines the input device type to emulate based on an input received from a control device or user interface of emulating device 106.

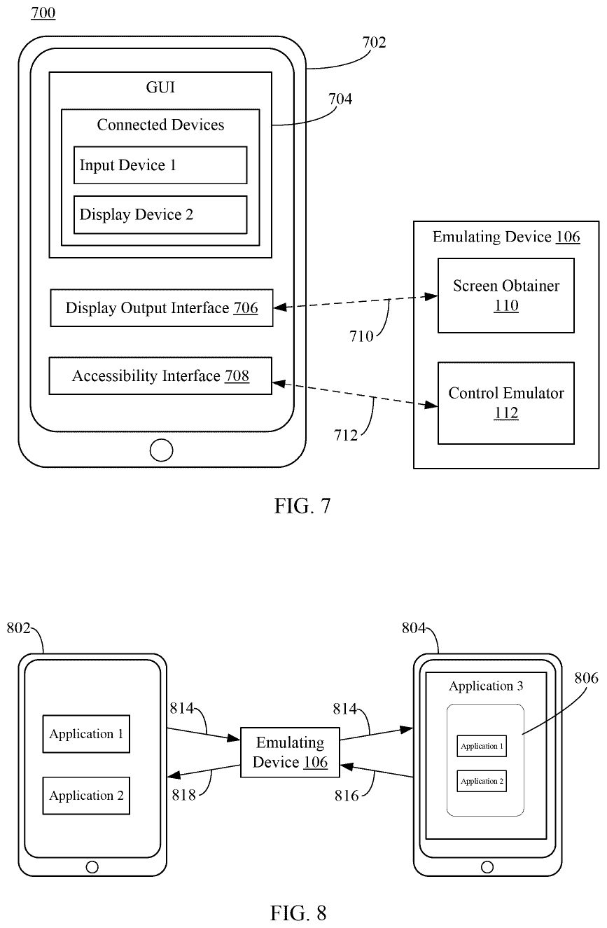

In some embodiments, control emulator 112 emulates an input device based on settings of mobile device 104. For example, in accordance with an embodiment, control of mobile device 104 by external devices is restricted to input devices capable of interfacing with an accessibility interface of mobile device 104 to provide input user interface commands. In this context, control emulator 112 emulates an input device in a manner that enables emulating device 106 to interface with the accessibility interface of mobile device 104. Further details regarding interfacing with accessibility interfaces are discussed with respect to FIG. 7, as well as elsewhere herein.

Control emulator 112 may be configured to receive control commands and convert control commands to input commands in various ways. As shown in FIG. 1, control emulator 112 receives a control command 116 from computing device 102 over network 120 via communication interface 108. Control command 116 may comprise instructions to open an application, select a location or object on the screen of mobile device 104, close an application, press a button of mobile device 104, switch a switch of mobile device 104, type text, draw an image, provide a multi-touch input, drag an object in a display area, drop an object in the display area, issue a voice command, and/or otherwise interact with mobile device 104. Examples of control command 116 include, but are not limited to, a voice command, a text command, a command corresponding to an input device or component of computing device 102 (e.g., a keyboard of computing device 102, a mouse of computing device 102, a touch screen of computing device 102, a stylus of computing device 102, a game controller of computing device 102, a joystick of computing device 102, a microphone of computing device 102, and/or the like). Control emulator 112 is configured to analyze control command 116 to determine a protocol of control command 116, determine a device type of computing device 102, determine an action that control command 116 corresponds to (e.g., based on the instructions included therein), and/or any other information associated with control command 116.

As further shown in FIG. 1, control emulator 112 converts control command 116 to an input command 118. In embodiments, control emulator 112 converts control command 116 based on the input device emulated by control emulator 112. In accordance with an embodiment, control emulator 112 converts control command 116 to an input command 118 based on a setting of mobile device 104 (e.g., an accessibility setting). Examples of input command 118 include, but are not limited to, a voice command (e.g., an audio signal corresponding to a voice command or a voice command determined by control emulator 112 (e.g., from an audio signal)), a key input of an emulated keyboard, a button press of an emulated input device, movement input of an emulated device (e.g., movement of a mouse, touch input dragging across a screen, movement of a joystick, etc.). As further shown in FIG. 1, control emulator 112 transmits input command 118 to mobile device 104.

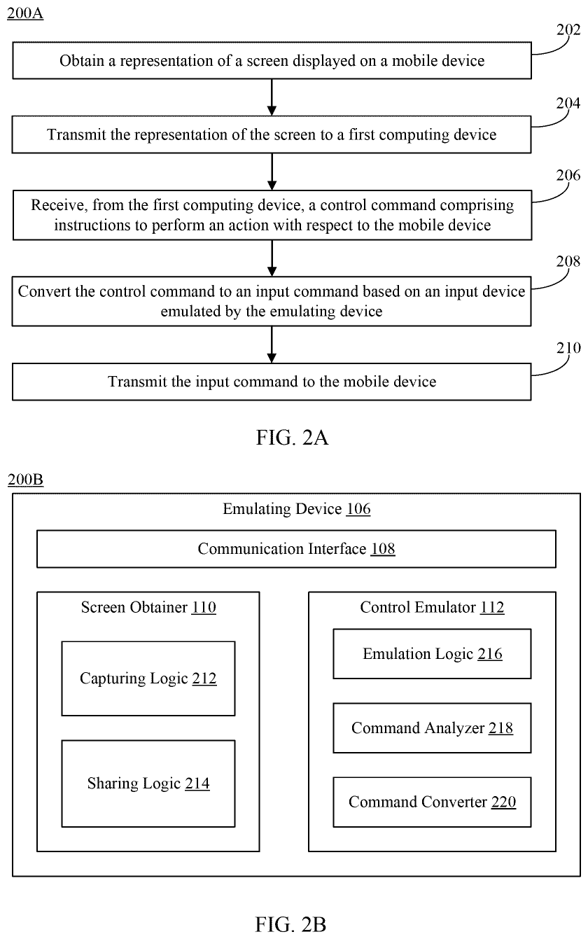

Emulating device 106 of FIG. 1 may operate to enable remote control of a mobile device in various ways, in embodiments. For example, FIG. 2A is a flowchart 200A of a process for remotely controlling a mobile device, according to another exemplary embodiment. Emulating device 106 may operate according to flowchart 200A in embodiments. For purpose of illustration, flowchart 200A of FIG. 2A is described with respect to FIG. 2B. FIG. 2B is an example block diagram 200B of emulating device 106 of FIG. 1. As shown in FIG. 2B, emulating device 106 includes communication interface 108, screen obtainer 110, and control emulator 112, as described with respect to FIG. 1. As further shown in FIG. 2B, screen obtainer 110 comprises capturing logic 212 and sharing logic 214, and control emulator 112 comprises emulation logic 216, a command analyzer 218, and a command converter 220. Capturing logic 212 enables obtaining representations of screens from mobile devices coupled to emulating device 106. Sharing logic 214 enables sharing representations of screens to remote computing devices. Emulation logic 216 enables and manages the emulation of input devices. Command analyzer 218 analyzes commands received from remote computing devices. Command converter 220 converts commands to input commands. Not all steps of flowchart 200A need be performed in all embodiments. Further structural and operational embodiments will be apparent to persons skilled in the relevant art(s) based on the following description of FIGS. 2A and 2B.

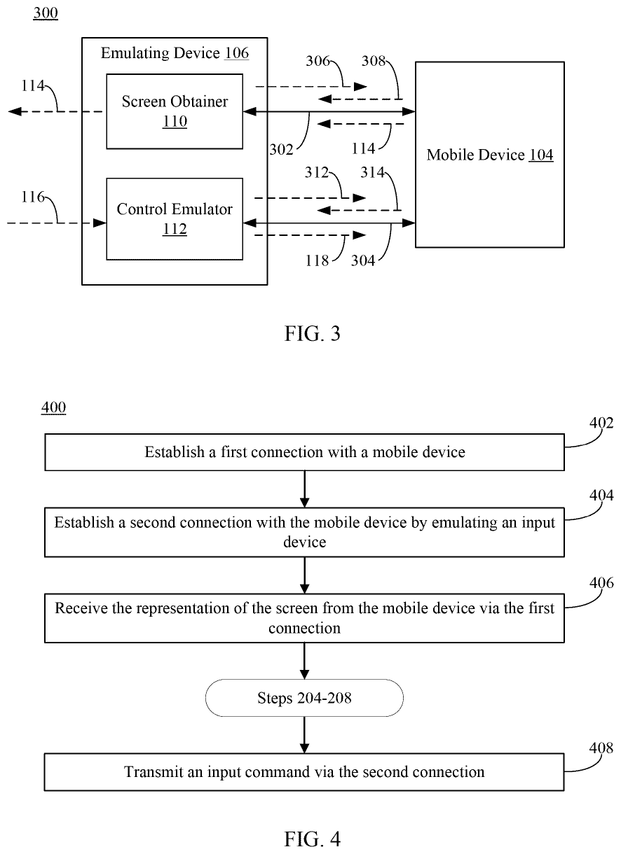

Flowchart 200A begins with step 202. In step 202, a representation of a screen displayed on a mobile device is obtained. For example, capturing logic 212 of FIG. 2B obtains representation 114 from mobile device 104 of FIG. 1. In accordance with an embodiment, capturing logic 212 obtains representation 114 via a wired connection between emulating device 106 and mobile device 104. In this context, capturing logic 212 receives representation 114 via a port of emulating device 106 (e.g., a USB port, an HDMI port, an ethernet port, an A/V port, a Lighting port, etc.). In accordance with another embodiment, capturing logic 212 communicates with mobile device 104 over a wireless connection (e.g., a LAN, a PAN, a Bluetooth network, an NFC connection, etc.) to obtain representation 114. As discussed further with respect to FIGS. 3 and 4, capturing logic 212 may be configured to establish a connection with mobile device 104 (e.g., over a wired connection, a wireless connection, or a combination of wired and wireless connections). Alternatively, and as discussed further with respect to FIGS. 5 and 6, capturing logic 212 may be configured to establish a connection with an application executing on mobile device 104.

Capturing logic 212 in accordance with an embodiment is configured to control the obtaining of representation 114 from mobile device 104 (e.g., by controlling a screen capture of the screen displayed by mobile device 104). For instance, capturing logic 212 may transmit a request to capture the screen to mobile device 104 or an application executing thereon. Alternatively, capturing logic 212 obtains representation 114 from video and/or image signals provided to emulating device 106 by mobile device 104. For instance, as described further with respect to FIG. 9, emulating device 106 in accordance with an embodiment is a switching device that receives media content signals from source devices. As an example, suppose mobile device 104 provides a display output to emulating device 106 (i.e., a display output comprising a representation of the screen displayed on mobile device 104). In this example, further suppose capturing logic 212 is configured to access the provided display output and capture the display output.

In step 204, the representation of the screen is transmitted to a first computing device. For example, sharing logic 214 of FIG. 2B transmits representation 114 to computing device 102 of FIG. 1 (e.g., via communication interface 108). For instance, sharing logic 214 transmits, to computing device 102, representation 114 obtained (e.g., received, captured, etc.) by capturing logic 212. In accordance with an embodiment, sharing logic 214 streams updated versions of representation 114 to computing device 102 via communication interface 108. In accordance with an embodiment, sharing logic 214 modifies representation 114 (e.g., converts a file format of representation 114, compresses representation 114, and/or otherwise modifies representation 114) and/or includes additional information with representation 114 in a transmission provided to computing device 102. For instance, sharing logic 214 may include, along with representation 114 (or in a communication separate from (e.g., preceding, subsequent to, concurrent with) the transmission comprising representation 114), an identifier of mobile device 104, an identifier of a user associated with mobile device 104, geographic data of mobile device 104, an authentication of a connection between mobile device 104 and emulating device 106, a configuration of mobile device 104 (e.g., accessibility configurations, network communication configurations, etc.), applications executing and/or installed on mobile device 104, input devices emulating device 106 is capable of emulating, the input device emulating device 106 is emulating with respect to mobile device 104, and/or any other information associated with mobile device 104 and/or emulating device 106.

In step 206, a control command is received from the first computing device. The control command comprises instructions to perform an action with respect to the mobile device. For example, command analyzer 218 receives control command 116 from computing device 102 of FIG. 1 (e.g., via communication interface 108). In accordance with an embodiment command analyzer 218 is configured to analyze control command 116 to determine a protocol of control command 116, to determine a device type of the computing device (i.e., computing device 102) that issued control command 116, to determine an action control command 116 corresponds to (e.g., opening an application, tapping a location on a screen, closing an application, pressing a button, switching a switch, typing text, drawing an image, providing a multi-touch input, dragging an object in a display area, dropping an object in a display area, and/or otherwise interacting with a display area (or objects displayed therein) of representation 114.

As noted elsewhere herein, control command 116 may comprises a voice command. In accordance with an embodiment, command analyzer 218 analyzes the voice command and determines a corresponding action. As a non-limiting example, suppose the voice command comprised an audio signal stating “Open Application 1” In this context, command analyzer 218 may determine the corresponding action is to open Application 1, to select an icon on the display screen of mobile device 104 that corresponds to Application 1, to pass the voice command to mobile device 104, and/or to perform another action that is related to opening Application 1. In accordance with an embodiment, command analyzer 218 determines the corresponding action based on an analysis of control command 116, the input device emulated by emulation logic 216, and/or a setting of mobile device 106 (e.g., an accessibility setting).

In step 208, the control command is converted to an input command based on an input device emulated by the emulating device. For example, command converter 220 of FIG. 2 converts control command 116 of FIG. 1 to input command 118 based on the input device emulated by emulation logic 216. To convert control command 116, command converter 220 may determine the type of device emulation logic 216 is emulating. In accordance with an embodiment, command converter 220 converts control command 116 to input command 118 according to a communication protocol between mobile device 104 and emulating device 106 (e.g., a USB protocol, a HDMI protocol, a communication protocol of mobile device 104, a communication protocol of emulating device 106, etc.). In accordance with an embodiment, command converter 220 converts control command 116 to input command 118 based on a setting of mobile device 104 (e.g., an accessibility setting).

As noted elsewhere herein, control command 116 may comprise a voice command. In accordance with an embodiment, command converter 220 converts the voice command to another type of input command (e.g., a key input of a keyboard, a button click, a movement input, etc.). In accordance with another embodiment, command converter 220 converts the voice command by modifying the voice command (e.g., trimming a length of audio of the voice command, converting a signal or file type of the voice command, compressing audio of the voice command, and/or otherwise modifying the voice command). In accordance with another embodiment, command converter 220 passes the voice command to mobile device 104 (e.g., without converting control command 116).

In step 210, the input command is transmitted to the mobile device. For example, command converter 220 of FIG. 2 transmits input command 118 to mobile device 104 of FIG. 1. For example, command converter 220 transmits input command 118 to mobile device 104 (e.g., over a connection established between emulating device 106 and mobile device 104).

As noted elsewhere herein, input command 118 may comprise a voice command (or, alternatively, command converter 220 may pass a voice command of control command 116 to mobile device 104). In accordance with an embodiment, command converter 220 transmits the command over the connection established between emulating device 106 and mobile device 104 (e.g., as an audio signal). In accordance with an alternative embodiment, command converter 220 transmits input command 118 as audio played over a speaker (e.g., a speaker of emulating device 106 or a speaker coupled to emulating device, not shown in FIG. 2B for brevity). For instance, as a non-limiting example, suppose input command 118 is a voice command. In this example, command converter 220 may be configured to transmit input command 118 as audio over a speaker of emulating device 106. In this example, mobile device 104 captures the audio via a microphone of mobile device 104 or a microphone coupled to mobile device 104

### III. Example Embodiments for Establishing and Using Connections with Devices

Embodiments of emulating devices have been described herein with respect to obtaining representations of screens from and transmitting input commands to mobile devices. In some embodiments, an emulating device (e.g., emulating device 106) obtains representations of screens from a mobile device (e.g., mobile device 104) and transmits input commands to the mobile device utilizing the same connection (e.g., a wireless connection, a wired connection, or a combination of wireless and wired connections). Alternatively, the emulating device obtains representations of a screen displayed by the mobile device via a first connection and transmits input commands to the mobile device via a second (e.g., separate) connection.

Emulating device 106 may be configured to receive representations of a screen from a mobile device and enable remote control of the mobile device in various ways, in embodiments. For instance, as noted above, emulating device 106 may use a first connection to receive representations of a screen displayed by mobile device 104 and a second connection to transmit input commands to mobile device 104. Emulating device may be configured to establish and use such connections in various ways, in embodiments. For example, FIG. 3 is a block diagram of a system 300 for receiving a representation of a screen from a mobile device via a local connection and remotely controlling the mobile device, according to an exemplary embodiment. As shown in FIG. 3, system 300 comprises emulating device 106 (comprising screen obtainer 110 and control emulator 112) and mobile device 104 of FIG. 1. Emulating device 106 also comprises communication interface 108, not shown in FIG. 3 for simplicity. For illustrative purposes, system 300 is described with respect to FIG. 4. FIG. 4 is a flowchart 400 of a process for receiving a representation of a screen from a mobile device via a local connection and remotely controlling the mobile device, according to an exemplary embodiment. Emulating device 106 of FIG. 3 may operate according to flowchart 400, in embodiments. Not all steps of flowchart 400 need be performed in all embodiments. Further structural and operational embodiments will be apparent to persons skilled in the relevant art(s) based on the following description of FIGS. 3 and 4.

Flowchart 400 starts with step 402. In step 402, a first connection is established with a mobile device. For example, screen obtainer 110 of FIG. 3 establishes a first connection 302 with mobile device 104. In accordance with an embodiment, first connection 302 is established by connecting a wire (e.g., a USB cable, a HDMI cable, a Lightning cable, an ethernet cable, etc.) between a port of emulating device 106 and a port of mobile device 104. Alternatively, first connection 302 is established using a wireless connection (e.g., Bluetooth, Wi-Fi, an NFC connection, or another type of wireless connection).

In some embodiments, establishing first connection 302 includes a handshake process between emulating device 106 and mobile device 104. For example, as shown in FIG. 3, screen obtainer 110 transmits a connection request 306 to mobile device 104. Connection request 306 may comprise an identifier of emulating device 106 (e.g., a MAC address of emulating device 106, an IP address of emulating device 106, a type of device of emulating device 106, a brand name of emulating device 106, a manufacturer of emulating device 106, a model number of emulating device 106, etc.), an intended use of representations obtained from mobile device 104 (e.g., transmitting representations (e.g., to computing device 102), recording or storing representations, editing representations, etc.), and/or any other information associated with emulating device 106 and/or techniques for obtaining (e.g., capturing) representations of screens displayed by mobile device 104. As further shown in FIG. 3, mobile device 104 transmits a connection response 308 to emulating device 106. In accordance with an embodiment, connection response 308 indicates connection to mobile device 104 is authorized or otherwise successful.

In step 404, a second connection is established with the mobile device by emulating an input device. For example, control emulator 112 of FIG. 3 establishes a second connection 304 with mobile device 104. In accordance with an embodiment, second connection 304 is established by connecting a wire (e.g., a USB cable, a HDMI cable, a Lightning cable, an ethernet cable, etc.) between a port of emulating device 106 (e.g., a different port than a port used for first connection 302) and a port of mobile device 104 (e.g., a different port than a port used for first connection 302). Alternatively, connection 304 is established using a wireless connection (e.g., a separate wireless connection from a wireless connection used to establish connection 302).

In some embodiments, establishing second connection 304 includes a handshake process between emulating device 106 and mobile device 104. For example, as shown in FIG. 3, control emulator 112 transmits a connection request 312 to mobile device 104. Connection request 312 may comprise an identifier of emulating device 106, an identifier of an input device emulated by control emulator 112, and/or any other information associated with emulating device 106, the emulated input device, and/or techniques for transmitting commands to mobile device 104. As further shown in FIG. 3, mobile device 104 transmits a connection response 314 to emulating device 106. In accordance with an embodiment, connection response 314 indicates connection to mobile device 104 (by emulated input device) is authorized or otherwise successful.

Flowchart 400 continues to step 406. Step 406 is a further embodiment of step 202 of flowchart 200A, as described with respect to FIG. 2A. In step 406, a representation of the screen is received from the mobile device via the first connection. For example, screen obtainer 110 of FIG. 3 receives representation 114 from mobile device 104 via first connection 302.

Flowchart 400 continues to steps 204-208, as described with respect to FIG. 2A. For example, as shown in FIG. 3, screen obtainer 110 transmits representation 114 to computing device 102 of FIG. 1 and control emulator 112 receives control command 116, and converts control command 116 to input command 118.

Flowchart 400 continues to step 408. Step 408 is a further embodiment of step 210 of flowchart 200A, as described with respect to FIG. 2A. In step 408, an input command is transmitted via the second connection. For example, control emulator 112 of FIG. 3 transmits input command 118 to mobile device 104 via second connection 304.

As noted above, emulating device 106 may obtain representations of a screen displayed by mobile device 104 from a screen capturing application executing on mobile device 104. In this context, emulating device 106 may establish a connection with the screen capturing application. Emulating device 106 may be configured to establish and use a connection with a screen capturing application in various ways, in embodiments. For example, FIG. 5 is a block diagram of a system 500 for receiving a representation of a screen from a mobile device via a screen capturing application and remotely controlling the mobile device, according to an exemplary embodiment. As shown in FIG. 5, system 500 comprises emulating device 106 (comprising screen obtainer 110 and control emulator 112) and mobile device 104 of FIG. 1. Emulating device 106 also comprises communication interface 108, not shown in FIG. 5 for simplicity. As further shown in FIG. 5, mobile device 104 comprises screen capturing application 512. In this context, screen capturing application 512 is an application executing on mobile device 512 that captures the screen displayed on mobile device 104. In accordance with an embodiment, screen capturing application 512 is a sub-service of an operating system of mobile device 104. Alternatively, screen capturing application 512 is an application downloaded on mobile device 104. As shown in FIG. 5, control emulator 112 of system 500 establishes and uses connection 304 in a similar manner described with respect to FIGS. 3 and 4.

For illustrative purposes, system 500 is described with respect to FIG. 6. FIG. 6 is a flowchart 600 of a process for receiving a representation of a screen from a mobile device via a screen capturing application and remotely controlling the mobile device, according to an exemplary embodiment. Emulating device 106 of FIG. 5 may operate according to flowchart 600, in embodiments. Not all steps of flowchart 600 need be performed in all embodiments. Further structural and operational embodiments will be apparent to persons skilled in the relevant art(s) based on the following description of FIGS. 5 and 6.

Flowchart 600 begins with step 602. Step 602 may be a further embodiment of step 402 of flowchart 400, as described with respect to FIG. 4. In step 602, a first connection is established with a screen capturing application executing on a mobile device. For example, screen obtainer 110 of FIG. 5 establishes a first connection 502 with screen capturing application 512. In accordance with an embodiment, first connection 502 is established by connecting a wire between a port of emulating device 106 and port of mobile device 104. Alternatively, first connection 502 is established using a wireless connection. In accordance with an embodiment, establishing first connection 502 includes a handshake process similar to that described with respect to step 402 of FIG. 4 (e.g., screen obtainer 110 transmitting a connection request 506 and screen capturing application 512 transmitting a connection response 508).

In accordance with an embodiment, screen capturing application 512 comprises a graphic user interface (GUI) (not shown in FIG. 5 for simplicity) that displays an indication that screen obtainer 110 is requesting a connection with screen capturing application 512. In this GUI, an option to approve or disapprove connection request 506 is provided. In response to selection of the option to approve connection request 506, screen capturing application 512 transmits connection response 508 and connection 502 is established. The GUI may also include an option to disable connection 502, an option to request a new connection be established, an option to scan for available emulating devices to establish connections with, a display of currently coupled devices, a display of whether or not screen capturing is activated, configuration options for capturing screens of mobile device 104, and/or other options or displays associated with the capture of a screen displayed by mobile device 104.

Flowchart 600 continues to step 604. Step 604 is a further embodiment of step 202 of flowchart 200A, as described with respect to FIG. 2A. In step 604, the representation of the screen is received from the screen capturing application executing on the mobile device. For example, screen obtainer 110 receives representation 114 from screen capturing application 512. In accordance with an embodiment, screen capturing application 512 (e.g., continuously) streams representation 114 to screen obtainer 110 via first connection 502. In accordance with another embodiment, screen capturing application 512 records an image or video representation of the screen displayed on mobile device 104 and provides the recorded image or video representation (e.g., as representation 114) to screen obtainer 110 via first connection 502.

Flowchart 600 continues to step 404 of flowchart 400, as described with respect to FIG. 4. In this context, flow continues with step 404 and proceeds as described elsewhere herein (e.g., to step 204 of flowchart 200A). Alternatively, step 404 is performed prior to step 604 (e.g., prior to step 602, subsequent to step 602, concurrent with step 602, etc.).

Several non-limiting examples are described with respect FIGS. 3-6 wherein a component of emulating device 106 (e.g., screen obtainer 110 or control emulator 112) requests to establish a connection to mobile device 104 or screen capturing application 512. However, it is also contemplated herein that mobile device 104 or screen capturing application 512 may be configured to request to establish a connection with emulating device 106 (or a component thereof). For instance, mobile device 104 (or screen capturing application 512) may be configured to scan for available devices over a network (e.g., nearby Bluetooth enabled devices, devices connected to the same Wi-Fi network, nearby devices with NFC enabled, etc.).

### IV. Example Embodiments Connected to Mobile Devices

Example embodiments of emulating devices (e.g., emulating device 106) have been described herein for enabling remote control of mobile devices (e.g., mobile device 104). In some embodiments, emulating device 106 of FIG. 1 is configured to connect (or pair) to mobile device for obtaining representations of a screen displayed thereon and for transmitting input commands to the mobile device. For instance, emulating device 106 may be connected to mobile device 104 of FIG. 1 via a first connection for obtaining representations of a screen displayed on mobile device 104 (e.g., as described with respect to steps 402 and 406 of FIG. 4, as described with respect to steps 602 and 604 of FIG. 6, and/or as otherwise described elsewhere herein). Furthermore, emulating device 106 may be further connected to mobile device 104 of FIG. 1 via a second connection for providing input commands to mobile device 104 (e.g., as described with respect to steps 404 and 408 of FIG. 4, as well as elsewhere herein). In embodiments, the emulating device 106 connects to mobile device 104 as emulating device 106 for obtaining representations of screens and connects to mobile device 104 by emulating an input device for providing input commands to mobile device 104. By forming separate connections with mobile device 702, emulating device 106 is enabled to capture a screen displayed on mobile device 104 and externally provide input commands to mobile device 104.

As noted elsewhere herein, some implementations of mobile devices are configured (e.g., by manufacturing settings, by operating settings, by security settings, by user settings, and/or by other configuration settings of the mobile device) to restrict control of the mobile device to input devices capable of interfacing with an accessibility interface of the mobile device to provide input user interface commands. To enable remote control of such a mobile device, embodiments of emulating device 106 are configured to emulate an input device in a manner that enables emulating device 106 to interface with such an accessibility interface. Emulating devices may be configured in various ways to interface with accessibility interfaces, in embodiments. For example, FIG. 7 is a block diagram of a system 700 including a mobile device paired to an emulating device, according to an exemplary embodiment. As shown in FIG. 7, system 700 comprises emulating device 106 (including screen obtainer 110 and control emulator 112) of FIG. 1 and a mobile device 702. Mobile device 702 is an example embodiment of mobile device 104, as described with respect to FIG. 1. As also shown in FIG. 7, mobile device 702 comprises a GUI 704, a display output interface 706, and an accessibility interface 708.

Display output interface 706 is configured to interface with devices via wired or wireless connections and transmit a display output of mobile device 702 via the connections to the devices. Display output interface 706 may comprise a physical port or a wireless interface of mobile device 702. Alternatively, display output interface 706 manages transmission of display output signals via a physical port or wireless interface of mobile device 702. As shown in FIG. 7, display output interface 706 interfaces with screen obtainer 110 of emulating device 710 via connection 710. Connection 710 may be established in various ways, as described elsewhere herein (e.g., in a manner similar to techniques described with respect to steps 402 and 406 of FIG. 4, techniques described with respect to steps 602 and 604 of FIG. 6, and/or other techniques described elsewhere herein).

Accessibility interface 708 is configured to interface with input devices capable of interfacing with accessibility interface 708 to provide input user interface commands. In accordance with an embodiment, the type of input devices accessibility interface 708 is capable of interfacing with are determined by a manufacturing setting of mobile device 702, a configuration setting of an operating system of mobile device 702, a configuration setting of accessibility interface 708, and/or the like. Furthermore, accessibility interface 708 may be further configured via user settings of mobile device 702. For instance, a user may interact with a GUI of mobile device 702 (e.g., GUI 704) to enable or disable accessibility interface 708. Furthermore, the user may interact with the GUI to enable a subset of devices capable of interfacing with accessibility interface 708 to interface accessibility interface 708. As a non-limiting example, a user may enable accessibility interface 708 for interfacing with a mouse but not a keyboard. Further still, a user may interact with a GUI to establish a connection 712 between accessibility interface 708 and an input device (e.g., emulating device 106). In accordance with an embodiment, connection 712 is established in a manner similar to that described with respect to steps 404 and 408 of FIG. 4, as well as elsewhere herein.

GUI 704 is configured to display information to a user of mobile device 702 and enable the user to provide input (e.g., by touching of a touch screen of mobile device 702, by pressing a button of mobile device 702, by using an input device interfacing with accessibility interface 708, by using a voice command captured by a microphone of mobile device 702 (not shown in FIG. 7), and/or the like) to mobile device 702 or an application executing thereon. In accordance with an embodiment, GUI 704 is an interface of an operating system of mobile device 702. In accordance with another embodiment, GUI 704 is an interface of an application executing on mobile device 702.

As noted above, GUI 704 may be configured to display various information to a user of mobile device 702. For instance, GUI 704 may be configured to display accessibility settings of mobile device 702, screen capturing settings of mobile device 702, display output settings of mobile device 702, devices connected to mobile device 702 (and/or information (e.g., identifiers) regarding the connected devices), an application executing on mobile device 702, a home screen of mobile device 702, a configuration menu of mobile device 702, a widget of mobile device 702, and/or any other information suitable for display by a GUI of a mobile device, as described elsewhere herein or as would be understood by a person ordinarily skilled in the relevant art(s) having benefit of this disclosure. For example, as shown in FIG. 7, GUI 704 is displaying a window labeled “Connected Devices” that lists devices connected to mobile device 702. In the window, a first object labeled “Input Device 1” and a second object labeled “Display Device 2” are shown. In this context, Input Device 1 corresponds to the input device emulated by control emulator 112 (e.g., connected via connection 712) and Display Device 2 corresponds to emulating device 106 (e.g., connected via connection 710).

As described herein, emulating devices enable remote control of a mobile device by obtaining representations of screens displayed on the mobile device, providing the representation to a remotely located computing device, receiving a control command from the remotely located computing device, converting the control command to an input command by emulating an input device, and transmitting the input command to the mobile device. By enabling remote control of a mobile device in this manner, a remote user of a remotely located computing device is able to view a display of the mobile device and externally control the mobile device.

To assist in illustrating the concepts described herein, FIG. 8 is described as follows. FIG. 8 is a block diagram of a system 800 for remotely controlling a mobile device, according to an exemplary embodiment. As shown in FIG. 8, system 800 comprises emulating device 106 as described with respect to FIG. 1, a first mobile device 802 (“mobile device 802” hereinafter), and a second mobile device 804 (“mobile device 804” hereinafter). Mobile device 802 displays a screen showing icons of two applications, labeled “Application 1” and “Application 2” respectively. Mobile device 804 displays a screen showing a GUI of an application, labeled “Application 3”. In this context, Application 3 is a remote viewing or remote desktop application that enables a user of mobile device 804 to view and interact with the display of mobile device 802.

To enable remote control of mobile device 802 by mobile device 804, emulating device 106 performs remote control enabling techniques described elsewhere herein. For instance, as shown in FIG. 8, emulating device 106 obtains a representation 814 of the screen displayed by mobile device 802 and transmits representation 814 to mobile device 804.

Mobile device 804 displays representation 814 as object 806 in the GUI of Application 3. A user of mobile device 804 is enabled to interact with object 806 to generate control commands. For instance, the user of mobile device 804 may select an icon of Application 1 or Application 2, tap a portion of the screen shown in object 806, provide a multi-touch input, initiate a drag-and-drop operation, perform a drag-and-drop operation, input a drawing or text, input a voice command (e.g., using a microphone of mobile device 804 not shown in FIG. 8 for brevity) to perform an action with respect to object 806, and/or otherwise interact with object 806. Application 3 generates a control command 816 based on the user's interaction with object 806. In this context, control command 816 may include the interaction, a type of the interaction, coordinates on object 806 associated with the interaction, a timestamp of the interaction, an identifier of the user, an identifier of Application 3, an identifier of mobile device 804, and/or any other information associated with providing control commands to control a mobile device.

Emulating device 106 receives control command 816 and converts control command 816 to input command 818 by emulating an input device capable of interfacing with an accessibility interface of mobile device 802. In embodiments, emulating device 106 converts control command 816 to input command 818 in accordance with techniques described elsewhere herein. Mobile device 802 receives input command 818 and a corresponding action is performed (i.e., an action corresponding to the user interaction with object 806).

In embodiments, representations of the screen displayed on mobile device 802 are continuously (or near continuously) streamed to emulating device 106 and from emulating device 106 to mobile device 804. In accordance with an embodiment, emulating device 106 converts a file format of or compresses the representation received from mobile device 802 prior to transmitting the representation to mobile device 804. In accordance with an embodiment, the representation is updated in response to mobile device 802 performing an action in response to receiving input command 818.

### V. Example Media System Embodiments

Turning now to FIG. 9, a block diagram of a media system 900 (“system 900” hereinafter) configured to enable remote control of a mobile device, according to an exemplary embodiment, is shown. System 900 is an example of system 100, as described with reference to FIG. 1. System 900 includes computing device 102 and mobile device 104 as described with reference to FIG. 1, as well as a switching device 902, a control device 904, consumer electronic devices 906A-906C, and one or more speakers 908 (“speakers 908” hereinafter). Switching device 902 is an example of emulating device 106 of FIG. 1.

Consumer electronic devices 906A and 906B are configured to provide media content signals for playback and are referred to as “source” devices. Media content signals may include audio signals, video signals, or a combination of audio and video signals. Consumer electronic device 906C is configured to receive media content signals and is referred to as a media presentation device and/or a “sink” device. Consumer electronic device 906C is coupled to speakers 908. Speakers 908 comprises one or more speakers and may be incorporated in consumer electronic device 906D, or alternatively, may be part of an external sound system that is coupled to consumer electronic device 906D and/or switching device 902. In an embodiment in which speakers 908 are part of an external sound system, speakers 908 may be communicatively coupled to consumer electronic device 906C via a wired interface (e.g., an HDMI cable, an optical cable, a universal serial bus (USB) cable, an Ethernet cable, etc.) or a wireless interface (e.g., Bluetooth, Wi-Fi, etc.).

As shown in FIG. 9, consumer electronic device 906A is coupled to a first port 910A of switching device 902, consumer electronic device 906B is coupled to a second port 910B of switching device 902, mobile device 104 is coupled to a third port 910C of switching device 902, and consumer electronic device 902C is coupled to a fourth port 910D of switching device 902. In accordance with an embodiment, ports 910A-910D are HDMI ports; however, embodiments described herein are not so limited. As further shown in FIG. 9, consumer electronic device 906A is a Blu-ray player, consumer electronic device 906B is a set-top box, and consumer electronic device 906C is a TV. The depiction of these particular electronics devices is merely for illustrative purposes. For instance, a consumer electronic device in accordance with another embodiment is a streaming media device. Examples of a streaming media device include, but are not limited to, a Roku™ device, an AppleTV™ device, a Chromecast™, and/or the like. It is noted that while FIG. 9 shows that switching device 902 includes four ports 910A-910D, switching device 902 may include any number of ports, and therefore, may be coupled to any number of consumer electronic devices. As described with respect to FIG. 9, ports 910A-910D are ports for receiving and/or providing media content signals (e.g., AV ports); however, switching device 102 may include other types of ports (not shown in FIG. 1), such as, but not limited to, input/output (IO) ports, network ports, and/or the like.

Control device 904 may be operable to control any or all of switching device 902, consumer electronic devices 906A-906C, and/or speakers 108. Control device 904 may include a display screen and/or one or more physical interface elements (e.g., buttons, sliders, jog shuttles, etc.). In accordance with an embodiment, the display screen (or a portion thereof) may be a capacitive touch display screen. The display screen may be configured to display one or more virtual interface elements (e.g., icons, buttons, search boxes, etc.). The display screen may be configured to enable a user to interact, view, search, and/or select content for viewing via any of switching device 902, consumer electronic devices 906A-906C, and/or speakers 908. In accordance with an embodiment, control device 904 comprises a microphone. Types of control device 904 include, but are not limited to, infrared (IR) remote controllers, Bluetooth controllers, mobile phones, universal remotes, and/or the like. As shown in FIG. 9, control device 904 is a separate device from mobile device 104. Alternatively, mobile device 104 is configured to operate as a control device. As shown in FIG. 9, system 900 includes one control device 904. Alternatively, multiple control devices may be used. For instance, each of switching device 902, consumer electronic devices 906A-906C, and/or speakers 908 may be controlled via a respective control device.

Switching device 902 is configured to select (e.g., switch between) different audio and/or video source devices that are coupled to ports 910A-910C (e.g., consumer electronic device 906A, consumer electronic device 906B, or mobile device 104) and provide an output signal comprising audio and/or video signals provided by the selected media content source device. Media content signals are provided to consumer electronic device 906C that is coupled to port 910D. Media content signals may also be provided to any other device capable of playing back audio and/or video signals (e.g., speaker(s) 908) that may be coupled consumer electronic device 906C and/or to port 906D and/or other port(s) (not shown) of switching device 902.

As further shown in FIG. 9, switching device 902 includes (e.g., AV, multimedia, etc.) ports 910A-910D, control logic 914, a switch circuit 916, a control interface 920, a network interface 922, a screen obtainer 930, and a control emulator 932. Screen obtainer 930 and control emulator 932 are respective further examples of screen obtainer 110 and control emulator 112, as described with respect to FIG. 1.

Switch circuit 916 may be implemented as hardware (e.g., electrical circuits), or hardware that executes one or both of software (e.g., as executed by a processor or processing device) and firmware. Switch circuit 916 is configured to operate and perform functions according to the embodiments described herein. For example, switch circuit 916 is configured to provide switched connections between ports 910A-910C and port 910D. That is, switch circuit 916 may receive input media content signals from source devices (e.g., consumer electronic device 906A, consumer electronic device 906B, and/or mobile device 104 via respective ports 910A-910C) and provide output media content signals to media presentation devices (e.g., consumer electronic device 906C via port 910D). Switch circuit 916 may comprise one or more switch circuit portions (e.g., comprising one or more switches/switching elements) and may be combined or used in conjunction with other portions of system 900.

Control logic 914 is configured to control switch circuit 916, receive signals from devices coupled to switching device 902 (e.g., from consumer electronic devices 906A-906C (e.g., via switch circuit 916), from speaker 908 (e.g., via switch circuit 916 and/or a (internal or external) microphone (not shown in FIG. 9 for brevity)), from control device 904 (e.g., via control interface 920 and/or network interface 922), from mobile device 104 (e.g., via switch circuit 916 and/or network interface 922), and/or from computing device 102 (e.g., via network interface 222)), receive signals from components of switching device 902 (e.g., switch circuit 916, control interface 920, network interface 922, screen obtainer 930, and/or control emulator 932), and/or provides signals to devices coupled to switching device 902 and/or to components of switching device 902. As shown in FIG. 9, control logic 914, screen obtainer 930, and control emulator 932 are separate components of switching device 902. However, it is also contemplated herein that screen obtainer 930 and/or control emulator 932 may be subcomponents of control logic 914.

Control logic 914 may include other components not shown in FIG. 9. For example, control logic 914 in accordance with one or more embodiments includes an identification component, one or more mapping components, and/or an action determination component. An identification component in accordance with an embodiment is configured to identify devices coupled to each of ports 210A-210D (e.g., consumer electronic devices 906A-906C and/or mobile device 104), determine identifier(s) thereof (e.g., a type of device (e.g., a DVD player, a Blu-ray player, a video game console, a streaming media device, a TV, an HDTV, a projector, a speaker, a mobile phone, etc.), a brand name of the device, a manufacturer of the device, a model number of the device, etc.), and/or provide identifier(s) to one or more mapping components. A mapping component in accordance with an embodiment is configured to determine a device-to-port mapping (e.g., based on identifier(s) received from an identification component). For example, a mapping component may generate a data structure (e.g., a table, a map, an array, etc.) that associates identifier(s) for any given identified device to the port to which that device is coupled (e.g., consumer electronic device 906A is a Blu-ray player coupled to port 910A, consumer electronic device 906B is a set-top box coupled to port 910B, mobile device 104 is a mobile phone coupled to port 910C, and consumer electronic device 906C is a TV coupled to port 910D, as shown in FIG. 9). An action determination component in accordance with an embodiment is configured to perform actions with respect to particular consumer electronic device (e.g., toggle power (i.e., to turn it off or on), issue an operational command (e.g., “play” or “pause”), transmit a notification message, automatically cause switch circuit 916 to connect a first port to which a particular source device (e.g., any of consumer electronic device 906A, consumer electronic device 906B, or mobile device 104) is connected to a second port to which a particular sink device (e.g., consumer electronic device 906C) is connected, issue commands from control emulator 932 to mobile device 104 (e.g., via port 910C, via network interface 922, or via another port of switching device 902 (not shown for brevity)), provide representations of screens displayed by mobile device 104 to screen obtainer 930, and/or facilitate communications between components of switching device 902 and computing device 102 (e.g., via network interface 922). In accordance with an embodiment, an action determination component determines actions to be performed based on another mapping component that maps particular actions to one or more particular consumer electronic devices.

Control interface 920 may comprise a receiver configured to receive wireless control signals from a device (e.g., mobile device 104, control device 904, a computing device configured to control switching device 902, consumer electronic device(s) 906A-906C, speaker 208, etc.). Control interface 220 may be configured to receive, detect, and/or sniff wireless control signals from a plurality of different control devices (e.g., including control device 904), for example, a dedicated control device configured to control switching device 902, or dedicated control devices each configured to control a respective device of consumer electronic device(s) 906A-906C and/or speakers 908. For instance, control interface 920 may comprise a wireless receiver configured to receive control signals transmitted from a control device (e.g., control device 904) via an IR-based protocol, an RF-based protocol, and/or an IP-based protocol. Upon detecting control signals, control interface 920 analyzes the control signals to identify one or more identifier(s) therein that uniquely identify the consumer electronic device for which the control signals are intended (e.g., consumer electronic device(s) 906A-906C and/or speaker 908). Control interface 920 may further determine a command (e.g., a toggle power-on/power-off command, play, fast-forward, pause, rewind, etc.) included in the control signals.

Network interface 922 is configured to interface with remote sites or one or more networks and/or devices via wired or wireless connections. Examples of networks include, but are not limited to, Bluetooth networks, PANs, LANs, WANs, the Internet, etc. In a particular example, and as shown in FIG. 9, computing device 102 and mobile device 104 are coupled to switching device 902 via network interface 222. For instance, as a non-limiting example, computing device 102 is coupled to switching device 902 via network interface 222 over the Internet and mobile device 104 is coupled to switching device 902 via network interface over a Bluetooth network.

As noted herein, screen obtainer 930 is a further embodiment of screen obtainer 110 described with respect to FIG. 1. Screen obtainer 930 is configured to obtain a representation of a screen displayed on mobile device 104 and transmit the representation of the screen to computing device 102. Screen obtainer 930 may obtain the representation of the screen in various ways. For instance, in accordance with an embodiment, screen obtainer 930 obtains the representation of the screen via a media content signal received by switching device 902 from mobile device 104 at port 910C. In this example, control logic 914 obtains the signal from switch circuit 916 and provides the obtained signal to screen obtainer 930. Control logic 914 may determine which port to obtain the signal from using a device-to-port mapping (e.g., of a mapping component). Alternatively, screen obtainer 930 obtains the representation of the screen via network interface 922 (e.g., over an NFC network, a PAN, a Bluetooth network, a LAN, or another network connection established between mobile device 104 and switching device 902). For instance, as a non-limiting example, suppose switching device 902 and mobile device 104 are connected to the same Wi-Fi network. In this example, mobile device 104 (or an application executing on mobile device 104) may be configured to provide the representation of the screen displayed on mobile device 104 to switching device 902.

As noted herein, control emulator 932 is a further embodiment of control emulator 112 described with respect to FIG. 1. Control emulator 932 is configured to emulate an input device, receive control commands from computing device 102 (e.g., via network interface 922), convert the received control command to an input command based on the emulated input device, and transmit the input command to mobile device 104. Control emulator 932 may transmit the input command to mobile device 104 in various ways. For instance, control emulator 932 in accordance with an embodiment transmits the input command to mobile device 104 via port 910C. In this context, control emulator 932 provides the input command to control logic 914, and control logic 914 transmits the input command to mobile device 104 via switch circuit 916 and port 910C. Control logic 914 may determine which port to transmit the input command to using a device-to-port mapping (e.g., of a mapping component). Alternatively, control emulator 932 transmits the input command to mobile device 104 via network interface 922 (e.g., over a network connection established between mobile device 104 and switching device 902). In accordance with an embodiment, control emulator 932 transmits the input command to mobile device 104 via a separate connection to mobile device 104 than the connection used to obtain the representation of the screen displayed on mobile device 104.

### VI. Further Example Embodiments and Advantages

One or more embodiments described herein may perform their functions according to the flowcharts described herein. Additional structural and operational embodiments will be apparent to persons skilled in the relevant art(s) based on the discussions regarding the flowcharts and embodiments herein. In some example embodiments, one or more of the steps of the described flowcharts may not be performed. Moreover, steps in addition to or in lieu of the steps of the described flowcharts may be performed (some of which were described above). Further, in some example embodiments, one or more of the steps of the described flowcharts may be performed out of the order shown or described, in an alternate sequence, and/or partially (or completely) concurrently with other steps.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

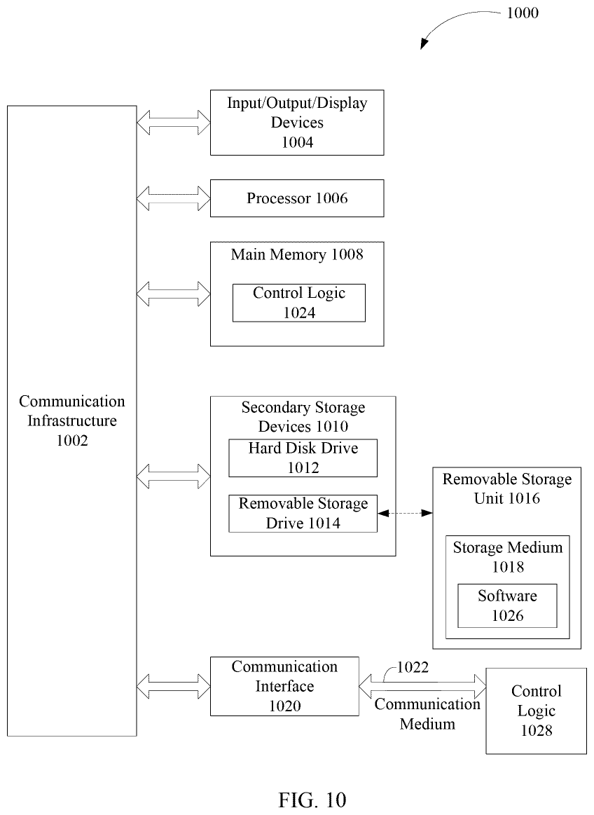

The embodiments described herein, including systems, methods/processes, devices, and/or apparatuses, may be implemented using well known processing devices, telephones (smart phones and/or mobile phones), tablet computers, servers, and/or, computers, such as a computer 1000 shown in FIG. 10. It should be noted that computer 1000 may represent communication devices, processing devices, servers, and/or traditional computers in one or more embodiments. For example, the techniques and/or systems for enabling remote control of a mobile device, and any of the sub-steps and/or sub-systems, may be implemented using one or more computers 1000 or portions thereof.

Computer 1000 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 1000 may be any type of computer, including a desktop computer, a server, etc.

Computer 1000 includes one or more processors (also called central processing units, or CPUs), such as a processor 1006. Processor 1006 is connected to a communication infrastructure 1002, such as a communication bus. In some embodiments, processor 1006 can simultaneously operate multiple computing threads.

Computer 1000 also includes a primary or main memory 1008, such as random access memory (RAM). Main memory 1008 has stored therein control logic 1024 (computer software), and data.

Computer 1000 also includes one or more secondary storage devices 1010. Secondary storage devices 1010 include, for example, a hard disk drive 1012 and/or a removable storage device or drive 1014, as well as other types of storage devices, such as memory cards and memory sticks. For instance, computer 1000 may include an industry standard interface, such a universal serial bus (USB) interface for interfacing with devices such as a memory stick. Removable storage drive 1014 represents a floppy disk drive, a magnetic tape drive, a compact disk drive, an optical storage device, tape backup, etc.

Removable storage drive 1014 interacts with a removable storage unit 1016. Removable storage unit 1016 includes a computer useable or readable storage medium 1018 having stored therein computer software 1026 (control logic) and/or data. Removable storage unit 1016 represents a floppy disk, magnetic tape, compact disk, DVD, optical storage disk, or any other computer data storage device. Removable storage drive 1014 reads from and/or writes to removable storage unit 1016 in a well-known manner.

Computer 1000 also includes input/output/display devices 1004, such as touchscreens, LED and LCD displays, monitors, keyboards, pointing devices, etc.

Computer 1000 further includes a communication or network interface 1020. Communication interface 1020 enables computer 1000 to communicate with remote devices. For example, communication interface 1020 allows computer 1000 to communicate over communication networks or mediums 1022 (representing a form of a computer useable or readable medium), such as LANs, WANs, the Internet, etc. Network interface 1020 may interface with remote sites or networks via wired or wireless connections.

Control logic 1028 may be transmitted to and from computer 1000 via the communication medium 1022.

Any apparatus or manufacture comprising a computer useable or readable medium having control logic (software) stored therein is referred to herein as a computer program product or program storage device. This includes, but is not limited to, computer 1000, main memory 1008, secondary storage devices 1010, and removable storage unit 1016. Such computer program products, having control logic stored therein that, when executed by one or more data processing devices, cause such data processing devices to operate as described herein, represent embodiments of the invention.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the figures, as well as any and all components, capabilities, and functions therein and/or further embodiments described herein.

Such computer-readable storage media are distinguished from and non-overlapping with communication media and transitory signals (do not include communication media and transitory signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The techniques and embodiments described herein may be implemented as, or in, various types of devices. For instance, embodiments may be included, without limitation, in processing devices (e.g., illustrated in FIG. 10) such as computers and servers, as well as communication systems such as switches, routers, gateways, and/or the like, communication devices such as smart phones, home electronics, gaming consoles, entertainment devices/systems, etc. A device, as defined herein, is a machine or manufacture as defined by 35 U.S.C. § 101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 1006 of FIG. 10), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### VII. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. An emulating device comprising:
a processor circuit; and
a memory that stores program code structured to cause the processor circuit to:
obtain a representation of a screen displayed on a mobile device;
transmit the representation of the screen to a first computing device;
receive, from the first computing device, a control command comprising instructions to perform an action with respect to the mobile device;
convert the control command to an input command based on an input device emulated by the emulating device; and
transmit the input command to the mobile device.

2. The emulating device of claim 1, wherein the program code is further structured to cause the processor circuit to:
establish a connection with the mobile device by emulating the input device; and
transmit the input command via the established connection.

3. The emulating device of claim 1, wherein:
control of the mobile device by external devices is restricted to input devices capable of interfacing with an accessibility interface of the mobile device to provide input user interface commands; and
the emulating device interfaces with the accessibility interface.

4. The emulating device of claim 1, wherein the emulating device is configured to:
emulate a microphone input device;
emulate a universal switch input device;
emulate a game controller input device;
emulate a joystick input device;
emulate a keyboard input device; or
emulate a mouse input device.

5. The emulating device of claim 1, wherein the emulating device is coupled to the mobile device by a local connection, the local connection comprising:
a wired connection; or
a peer-to-peer network connection.

6. The emulating device of claim 5, wherein the emulating device is coupled to the first computing device by a wireless network.

7. The emulating device of claim 5, wherein to enable the processor circuit to obtain the representation of the screen, the emulating device is configured to receive a video signal from the mobile device via the local connection.

8. The emulating device of claim 1, wherein to enable the processor circuit to obtain the representation of a screen, the emulating device is configured to receive the representation of the screen from a screen capturing application executing on the mobile device.

9. The emulating device of claim 1, wherein the emulating device is:
a switching device;
a mobile device dock; or
a second computing device.

10. A method performed by an emulating device comprising:
obtaining a representation of a screen displayed on a mobile device;
transmitting the representation of the screen to a first computing device;
receiving, from the first computing device, a control command comprising instructions to perform an action with respect to the mobile device;
converting the control command to an input command based on an input device emulated by the emulating device; and
transmitting the input command to the mobile device.

11. The method of claim 10, further comprising:
establishing a connection with the mobile device by emulating the input device; and
transmitting the input command via the established connection.

12. The method of claim 10, wherein:
control of the mobile device by external devices is restricted to input devices capable of interfacing with an accessibility interface of the mobile device to provide input user interface commands; and
the emulating device interfaces with the accessibility interface.

13. The method of claim 10, further comprising
emulating a microphone input device;
emulating a universal switch input device;
emulating a game controller input device;
emulating a joystick input device;
emulating a keyboard input device; or
emulating a mouse input device.

14. The method of claim 10, wherein said obtaining a representation of a screen comprises:
receiving a video signal from the mobile device via a local connection between the mobile device and the emulating device; or
receiving the representation of the screen from a screen capturing application executing on the mobile device.

15. A switching device, comprising:
a plurality of ports comprising a first port communicatively coupled to a mobile device;
a screen obtainer configured to:
obtain a representation of a screen displayed on the mobile device, and
transmit the representation of the screen to a first computing device; and
a control emulator configured to:
receive, from the first computing device, a control command comprising instructions to perform an action with respect to the mobile device,
convert the control command to an input command based on an input device emulated by the emulating device, and
transmit the input command to the mobile device.

16. The switching device of claim 15, wherein:
control of the mobile device by external devices is restricted to input devices capable of interfacing with an accessibility interface of the mobile device to provide input user interface commands; and
the control emulator interfaces with the accessibility interface.

17. The switching device of claim 15, wherein:
the switching device is configured to:
receive, at the first port, a media content signal from the mobile device;
to obtain a representation of a screen displayed on the mobile device, the switching device is further configured to:
capture the representation of the screen from the media content signal.

18. The switching device of claim 17, wherein:
the control emulator is communicatively coupled to the mobile device by an established connection, the established connection comprising:
a connection between a second port of the plurality of ports and the mobile device, or
a connection between a network interface of the switching device and the mobile device; and
to transmit the input command to the mobile device, the control emulator is configured to transmit the input command using the established connection.

19. The switching device of claim 15, wherein to transmit the input command to the mobile device, the control emulator is configured to:
transmit the input command via the first port.

20. The switching device of claim 15, wherein the control emulator is further configured to:
emulating a microphone input device;
emulate a universal switch input device;
emulate a game controller input device;
emulate a joystick input device;
emulate a keyboard input device; or
emulate a mouse input device.
